(19) United States
(12) Patent Application Publication
(10) Pub. No.: US 2024/0399990 A1
(43) Pub. Date: Dec. 5, 2024

(54) ROLL-FORMED VEHICLE REINFORCEMENT BEAM

(71) Applicant: Shape Corp., Grand Haven, MI (US)

(72) Inventors: Jeffrey A. McHenry, Norton Shores, MI (US); Joseph R. Matecki, Allendale, MI (US); Aniruddha S. Parab, Maharashtra (MH) (IN); Ed C. Pendergrass, West Olive, MI (US)

(21) Appl. No.: 18/678,678

(22) Filed: May 30, 2024

Related U.S. Application Data
(60) Provisional application No. 63/504,902, filed on May 30, 2023.

(51) Int. Cl. B60R 19/34; B60R 19/18

(52) U.S. Cl. CPC B60R 19/34; B60R 19/18

(57) ABSTRACT

A reinforcement beam for a vehicle has an outer beam profile and an inner beam profile. The outer beam profile define an elongated hollow body and includes a front wall portion and a rear wall portion. The outer beam profile may include upper and lower flanges that formed in planar extension of the font wall portion. The inner beam profile may include a C-shape defining an upper shear wall and a lower shear wall that each extend between the front wall portion and the rear wall portion. The outer beam profile and the inner beam profile may be formed from a single sheet material through a roll-forming process. The inner beam profile may be present over a central section of the elongated hollow body and have a length that is less than half the length of the elongated hollow body.

### CROSS-REFERENCE TO RELATED APPLICATION

This application claims the benefit and priority under 35 U.S.C. § 119 (e) of U.S. provisional application Ser. No. 63/504,902, filed on May 30, 2023, the content of which is incorporated herein by reference in its entirety.

### TECHNICAL FIELD

The present disclosure relates generally to reinforcement beams for vehicles, such as roll-formed bumper reinforcement beams for bumper assemblies, subassemblies, and components thereof.

### BACKGROUND

Vehicle bumper systems commonly include at least one reinforcement beam that spans across the front or rear end of the vehicle. The primary reinforcement beam is typically supported by crush cans that attach to the vehicle frame structure. Vehicle bumper systems undergo rigorous testing for impact energy management and absorption from high speed and low speed crash impacts, such as to comply with mandated government regulations and insurance certifications. For example, impact requirements and protocols for bumper systems are set forth by the United States Federal Motor Vehicle Safety Standards (US FMVSS), the Insurance Institute for Highway Safety (IIHS), the National Highway Traffic Safety Administration (NHTSA), the European EC E42 consumer legislation, and the Asian Pedestrian Protection for lower and upper legs, among others. Bumper systems are also designed to maximize strength-to-weight ratios in an effort to minimize the overall vehicle weight, while balancing the cost of the associated bumper system components. Conventional bumper reinforcement beams may involve multiple, separately formed components, which increases manufacturing time and costs.

### SUMMARY

This disclosure provides a reinforcement beam for a vehicle that functions to receive and absorb impact loads received from vehicle collisions, such as implementations of a bumper reinforcement beam that is configured to be supported by crush cans at a vehicle frame. The bumper reinforcement beam includes a cross-sectional profile having internal walls that may be formed of a single metal sheet with the external surfaces. Prior to roll-forming, the sheet may be cut or trimmed so that the internal walls are present in a central portion of the bumper reinforcement beam and omitted from end portions of the bumper reinforcement beam. The bumper reinforcement beam may include flanges extending at a top and a bottom edge of the cross-sectional profile for improved impact absorption over a rounded extension of the bumper reinforcement beam.

One aspect of the disclosure provides a bumper reinforcement beam that is configured to be supported by crush cans at a vehicle frame.

The inner walls may have a length between its opposing ends that is less than a half of the length of the outer beam profile. The first and second end sections of the outer beam that are disposed at opposing ends of the central section may be void of the inner beam profile.

The inner beam may have an intermediate portion that interconnects between the upper wall and the lower wall to together define a channel along the inner beam. The upper and lower walls of the inner beam may divide the interior volume of the hollow body to form a plurality of elongated hollow areas. In some examples, the inner beam profile has rear flanges that integrally extend from the upper and lower walls, the rear flanges coupled to the rear wall portion of the outer beam profile. The upper and lower walls of inner beam profile may extend rearward at an angle of between about 70° to about 90° relative a planar extent of the front wall portion. In certain aspect, the upper wall of inner beam profile extends rearward and upward at an angle of between 75° to 90° to a planar extent of the front wall portion. In some aspects, the lower wall of inner beam extends rearward and downward at an angle of between 75° to 90° relative to a planar extent of the front wall portion.

One aspect of the present disclosure provides a bumper reinforcement beam configured to be supported by crush cans at a vehicle frame, the bumper reinforcement beam including an outer beam profile having an elongated hollow body formed from a metal sheet material and configured to span laterally between the crush cans. The hollow body may have a front wall portion and a rear wall portion extending along a length defined between a first end and a second end of the hollow body. The bumper reinforcement beam may include an inner beam profile formed integrally with the outer beam profile. The inner beam profile may be disposed along a central section of the reinforcement beam between first and second lateral end sections. The inner beam profile may have an upper wall and a lower wall that each extend between the front wall and the rear wall of the outer beam. The inner beam profile of the reinforcement beam may include a middle wall disposed between the upper wall and the lower wall and extending between the front wall portion and the rear wall portion.

The central section may have a first length and the first and second lateral end sections may have respective second and third lengths. The first length may be less than the sum of the second and third lengths. The first length may be equal to the second length and to the third length.

The inner beam profile may include an intermediate portion that interconnects between the upper wall and the lower wall to together define a channel disposed within the outer beam profile. The intermediate portion may be adjacent the front wall portion of the outer beam profile. The intermediate portion of the inner beam profile may coupled to the front wall portion of the outer beam profile. The intermediate portion of the inner beam profile may joined to the front wall portion of the outer beam profile via welding or an adhesive.

The bumper reinforcement beam may include a single sheet material forming the outer beam profile and the inner beam profile. The single sheet material may include a first edge or end and a second edge or end. The first and second edges may be disposed adjacent to and coupled with a rear wall portion of the outer beam profile. The single sheet material forming the outer beam profile and the inner beam profile may include the first and second edges being disposed internal to the outer beam profile. The single sheet material may include a first edge or end and a second edge or end in the central portion, and a third edge or end and a fourth edge or end in the first and second lateral end sections. The first and second edges may be different from the third and fourth edges. One of the first or second edges may be the same as one of the third or fourth edges. The third and fourth edges may be spaced apart. The third and fourth edges may be joined together to form a closed cross section of the outer beam profile in the lateral end sections. The third and fourth edges may be joined together via welding. The inner beam profile may include one of the first or the second edges. The inner beam profile may include both of the first and second edges.

The bumper reinforcement beam may have a front wall portion of a first height, and the rear wall portion of a second height being less than the first height. The front wall portion may form an upper flange and a lower flange.

The bumper reinforcement beam may have a rear wall portion forming an attachment surface that is adapted for attachment to the crush cans.

One aspect of the present disclosure provides a bumper reinforcement beam configured to be supported by crush cans at a vehicle frame including a beam having a front wall portion, a rear wall portion and upper and lower wall portions. The beam wall portions may define an outer beam profile having a length configured to span between crush cans. The beam may include an inner beam profile extending between the front and rear wall portions and comprising a shear wall that extends between the front wall portion and the rear wall portion. The inner beam profile may have a length that is less than half the length of the outer beam profile.

One aspect of the present disclosure provides a reinforcement beam having an outer beam profile having a front wall portion, a rear wall portion, and upper and lower flanges that extend from the outer beam profile along respective upper and lower edges of the outer beam profile to define an elongated hollow body with a length defined between opposing ends of the outer beam profile. The reinforcement beam may include an inner beam profile comprising a C-shape having an upper shear wall and a lower shear wall that each extend between the front wall portion and the rear wall portion. The inner beam profile may have a length that is less than half the length of the elongated hollow body.

Each of the above independent aspects of the present disclosure, and those aspects described in the detailed description below, may include any of the features, options, and possibilities set out in the present disclosure and figures, including those under the other independent aspects, and may also include any combination of any of the features, options, and possibilities set out in the present disclosure and figures.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a schematic side elevation view of a vehicle having a bumper assembly including a reinforcement beam.

FIG. 2 is a schematic side elevation view of the reinforcement beam and the supporting crush can of FIG. 1.

FIG. 3 is a front elevation view of the reinforcement beam of FIGS. 1-2.

FIG. 4 is transverse cross-sectional view of the reinforcement beam of FIGS. 1-3 taken along the line IV-IV in FIG. 3.

FIGS. 5-6 is a transverse cross-sectional view of an example reinforcement beam.

FIGS. 7-8 is a transverse cross-sectional view of a second example reinforcement beam.

FIGS. 9-10 is a transverse cross-sectional view of a third example reinforcement beam.

FIGS. 11-12 is a transverse cross-sectional view of a fourth example reinforcement beam.

FIGS. 13-14 is a transverse cross-sectional view of a fifth example reinforcement beam.

FIGS. 15-16 is a transverse cross-sectional view of a sixth example reinforcement beam.

FIGS. 17-18 is a transverse cross-sectional view of a seventh example reinforcement beam.

Like reference numerals indicate like parts throughout the drawings.

### DETAILED DESCRIPTION

Reinforcement beams for vehicles are disclosed herein in various implementations as impact energy absorption and management devices that are used in conjunction with other vehicle components to absorb and manage impact loads and energy so as to minimize damage and intrusion during an impact to the vehicle. For example, a reinforcement beam may be employed at a bumper assembly that is attached to a vehicle frame, where the reinforcement beam is a cross car structure supported by crush cans. In some instances, vehicle bumper assemblies can have increased front end stiffness and impact energy absorption requirements, such as on electric vehicles or rear engine mounted vehicles with greater vehicle mass and front ends that may be more susceptible to impact intrusion. While it is generally known that bumper reinforcement beams with increased mass can function to meet increased stiffness requirements, increasing mass typically adds to the vehicle cost while also reducing efficiency. Reinforcement beams disclosed herein may provide increased stiffness being formed, for example by roll forming, of a single sheet of metal or other rigid material.

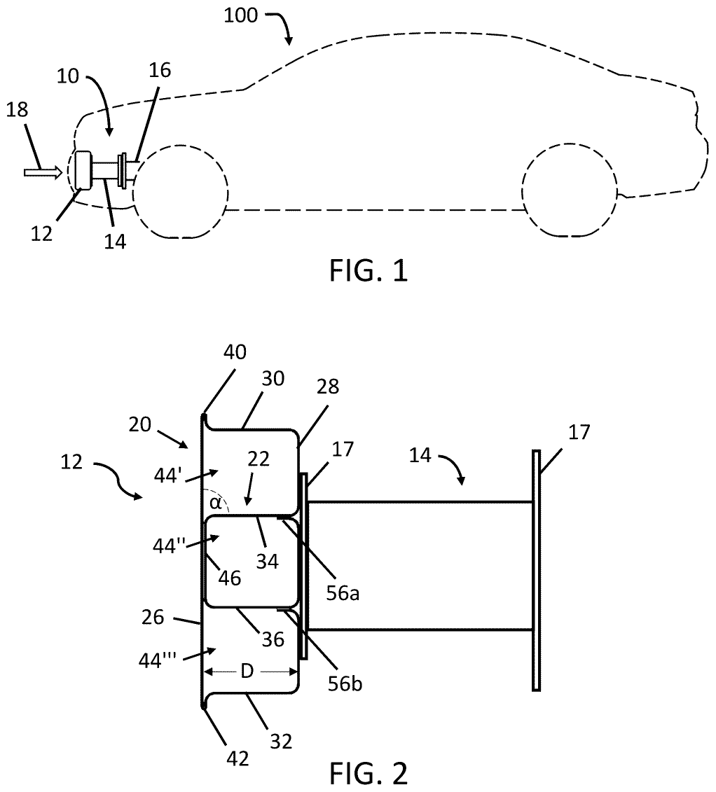

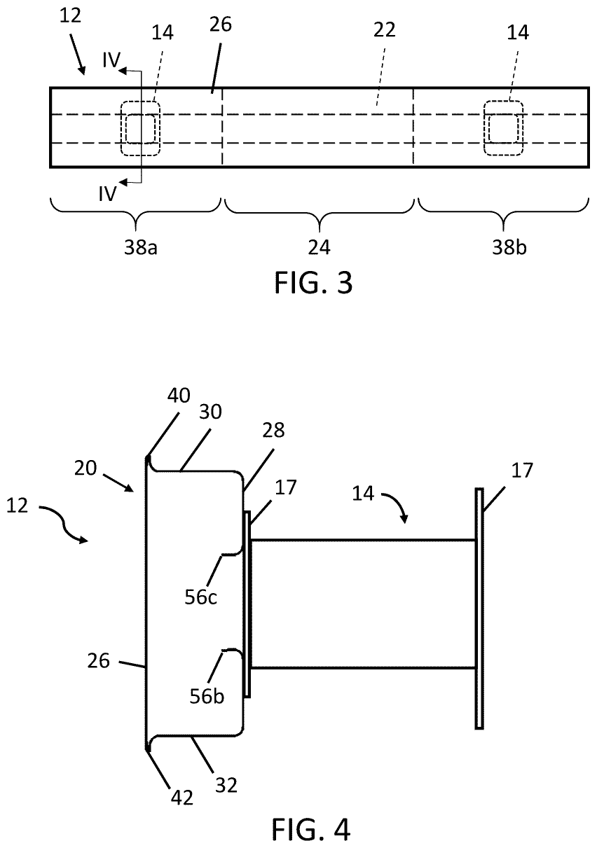

The reinforcement beam 12 of the disclosure includes an outer beam profile 20 and an inner beam profile 22 that reinforces a central section 24 (FIG. 3) of the reinforcement beam 12. The outer beam profile 20 defines an elongated hollow body formed from a metal sheet material, and may include a front wall portion 26 and a rear wall portion 28. The front wall portion 26 and rear wall portion 28 may be connected by a top wall portion 30 and a bottom wall portion 32. The front wall portion 26, rear wall portion 28, top wall portion 30 and bottom wall portion 32 together define the outer beam profile 20 and the elongated hollow body. The inner beam profile 22 reinforces a hollow area between the front wall portion 26 and the rear wall 32 of the outer beam profile 20 by providing an upper wall 34 and a lower wall 36 that each extend between the front wall portion 26 and rear wall portion 28. The upper and lower walls may also be referred to as shear walls and may be configured to undergo axial loading from impact forces to the bumper system. The reference to front and rear and other directional derivatives for this example of the reinforcement beam is in reference to its use on a front bumper assembly (FIG. 1) and its relative location on the associated vehicle 100; however, it is understood that the reinforcement beam disclosed herein may also be used on a rear bumper assembly or a side frame structure, such as a rocker or a battery tray side member, among other conceivable uses on a vehicle structure or subassembly to absorb and manage impact loads and energy. Consistent with the present disclosure, the reference to front may refer to the aspect proximate to the point of force application, but this is not intended to be limiting that the relative geometry may be reversed.

Referring now to the drawings and the illustrative examples depicted therein, a bumper assembly 10 for a vehicle 100, such as shown in FIG. 1, has a bumper reinforcement beam 12 that is supported by crush cans 14 that are attached to the bumper reinforcement beam 12 at generally equal spacing from a center of the bumper reinforcement beam 12. The crush cans 14 of the bumper assembly 10 each mount to an end or tip of a frame rail 16 or other supportive portion of a vehicle frame to position the bumper reinforcement beam 12 so that it spans laterally (in a width direction of the vehicle) across a front end of the vehicle 100. As shown in FIG. 1, the bumper assembly 10 is mounted at the front end of the vehicle 100, which may be a passenger vehicle or other type of motor vehicle, such as a car, truck, bus, van, or sport utility vehicle or the like. The crush can 14 functions to support the bumper reinforcement beam 12 at the vehicle frame 16 and to direct and absorb impact loads 18 received (in a longitudinal or x-direction relative to the vehicle) from the supported bumper reinforcement beam 12 to the attached frame 16 through the crush can 14. It is also contemplated that the bumper assembly and other implementations thereof may be used or otherwise incorporated into a rear end of a vehicle. Alternatively, the reinforcement beam 12 may be applied as a side frame structure, such as a rocker, or a battery tray side member, among other conceivable uses on a vehicle structure or subassembly.

As shown for example in FIG. 2, a bumper reinforcement beam 12 and crush can 14 are illustrated. The crush can 14 is formed as a thin-walled, hollow structure that is a frangible structure designed to crush to absorb impact energy received at the bumper reinforcement beam. The bumper assembly may include one or more attachment plates 17 between the crush can 14 and the bumper reinforcement beam 12 or between the crush can 14 and the vehicle frame component 16 (FIG. 1), or both. The one or more attachment plates 17 may include a distribution of apertures for attachment to the bumper reinforcement beam 12 or the vehicle frame component 16 with threaded or similar fasteners, such as bolts, rivets, or the like. The crush can 14 may be welded to the one or more attachment plates 17. Alternatively, the crush can 14 may be welded directly to the bumper reinforcement beam 12, or to the vehicle frame component 16, or both.

As further shown in FIGS. 2-4, the inner beam profile 22 of the bumper reinforcement beam 12 reinforces a central section 24 of the outer beam profile 20. The inner beam profile 22 has a length between its opposing ends that may be less than a half of the length of the outer beam profile 20. For example, the length of the outer beam component may be between approximately 800-1,200 mm, such as 1,000 mm, and the length of the inner beam profile 22 may be between approximately 300-600 mm, such as 400 mm. The top wall portion 30 and bottom wall portion 32, spanning between the front wall portion 26 and rear wall portion 28, provide a depth D to the outer beam profile 20. The depth D of the section may be constant along the length of the reinforcement beam 12, and may be generally proportional to the other features. In the example shown the depth is approximately 40 mm and in additional examples may be 50-70 mm or more or less. In other alternatives, the depth D may not be constant along the entire length of the reinforcement beam 12. For example, the depth D may be greater in the central section 24 where the inner beam profile 22 is present and may be smaller in the lateral end sections 38a, b. In a further alternative, the depth D may taper, varying continuously along the lateral end sections 38a, b from the central section 24 to the outer ends.

As shown in FIG. 3, the lateral end sections 38a, 38b of the outer beam profile 20 that are disposed at opposing ends of the central section 24 are void of the inner beam profile 22. The lateral end sections 38a, 38b, however, undergo less bending stress than the central section 24 due to the support to the outer beam profile 20 provided by the crush cans 14 at the lateral end sections 38a, 38b. Thus, the reinforcement provided by the inner beam profile 22 is not provided at the lateral end sections 38a, 38b. It is understood that the reinforcement beam may be longer in additional examples and that the impact location may vary from a central section in other implementations on the vehicle 100. In one alternative, the inner beam profile 22 may extend greater than a half of the length of the outer beam profile. For example, where the reinforcement beam is used as a battery tray side member, the inner beam profile 22 may extend the entire length of the outer beam profile 20 so that the entire beam is consistently reinforced. In another alternative, the inner beam profile may comprise two or more separate portions of the outer beam profile length, such as, for example, where a crush can is centrally disposed, in addition to being places near the ends of the reinforcement beam. The inner beam profile 20 may be present in two positions along the length of the reinforcement beam separated by a portion proximate the crush can where the inner beam profile 22 is absent.

As shown in FIG. 4, taken as a cross-section along the line IV-IV indicated in FIG. 3, the bumper reinforcement beam 12 is shown proximate the crush can, where the inner beam profile 22 is absent. The metal sheet from which the reinforcement beam 12 is formed may be cut or trimmed before it has been formed, for example, by roll-forming, into the illustrated cross sectional profiles. The roll-forming process may form the outer beam profile 20 and the inner beam profile 22 currently in a single continuous process, or the inner beam profile 22 may be formed in a first process where the outer beam profile 20 is formed in a subsequent process.

The bumper reinforcement beam 12 may include a curved shape or sweep that is imparted along the length of the beam 12. Such a curved shape or sweep may generally conform the beam to the package space permitted by the vehicle design. The curved shape may have a consistent radius of curvature along the length of the bumper reinforcement beam, or in additional examples may have a varied radius of curvature at different sections of the length, such as a greater curvature (and effectively a smaller radius of curvature) at the lateral end sections of the beam. The beam 12 may be formed into its outer beam profile 20 and inner beam profile 22 before being curved into its final arcuate shape. Alternatively, the outer beam profile 20 and inner beam profile 22 may be formed concurrently with being curved into its final arcuate shape. In certain applications, such as a battery tray side member, the beam 12 may be rectilinear along its entire length.

As illustrated in the example in FIGS. 2-4, the outer beam profile 20 defines an elongated hollow body formed from a metal sheet material. The metal sheet material may be formed to yield a front wall portion 26, rear wall portion 28, and top wall portion 30 and bottom wall portion 32 spanning between the front wall portion 26 and the rear wall portion 28. The several wall portions may be formed integrally with each other by bending operations or in a roll-forming process. The front wall portion 26 may have a height greater than the rear wall portion 28 so that the beam 12 concentrates a greater amount of force applied at the front wall portion 26 to a smaller area at the rear wall portion 28 and into the crush can 14. The extensions of the front wall portion 26 may be formed as upper flange 40 and lower flange 42. The flanges 40, 42 may assist in concentrating impact loads 18 in line with the top wall portion 30 and bottom wall portion 32 yielding an increase strength relative to an outer beam profile 20 that omits the flanges 40, 42. To further aid in strengthening the beam 12 at the bends forming the flanges 40, 42, an in-line heat treatment process, such as an in-line annealing, maybe performed before, during, or after the roll-forming process used to form the flanges 40, 42. In the illustrated beam 12, the upper and lower flanges 40, 42 extend vertically in planar extension of the front wall portion 26. This is not intended to be limiting, and the upper and lower flanges may be formed in planar extension of the rear wall portion 28, or may be formed as a ridge along the top wall portion 30 or bottom wall portion 32.

In one or more of the front wall portion 26, rear wall portion 28, top wall portion 30, or bottom wall portion 32, ribs, grooves, channels, or other reinforcing or crush-initiating features may be provided. The features may extend longitudinally along the length of the outer or inner beam profiles 20, 22, or may extend transversally across one or more of the front wall portion 26, rear wall portion 28, top wall portion 30, or bottom wall portion 32. There may be one or more features on a single wall portion, and each feature may have different shapes, dimensions, and positions. Also, the features may have a height vertically on a face and depth inward from the face of the wall that is configured to allow the sheet material to be formed inward in a generally curved shape without exceeding the allowable curvature (minimum capable bending radius) of the sheet material without failure. These types of features may provide additional stiffness to the wall portion or may control the initiation or deformation of the wall portion during a load impact.

The metal sheet material of the reinforcement beam 12 can comprise any metals or metal alloys that have the desired characteristics, such as stiffness, tensile strength, and the like. For example, the material may include aluminum or steel, such as a high strength or ultra-high strength steel, as well as combinations of other related metals in different alloys. The sheet material may be entirely or partial a non-sheet material, such as an injection molded polymer, a composite, an aluminum extrusion, or a composite pultrusion, or the like. The sheet material of the outer beam profile 20 may be formed in various processes, such as with the use of cold stamping, roll forming, roll stamping, hot stamping, press brake bending, or combinations thereof. References herein to a particular forming process should be understood as non-limiting. Selection of the appropriate forming process for a particular material and application of the presently disclosed reinforcement beam 12 may be understood as within the level of ordinary skill.

The metal sheet material may comprise a single material thickness throughout the outer beam profile 20 and the inner beam profile 22. Alternatively, the metal sheet material may have variable thickness. For example, the metal sheet material forming the outer beam profile 20 may comprise a first thickness and the metal sheet material forming the inner beam profile 22 may comprises a second thickness that is different from the first thickness. The first thickness may be thinner than the second thickness. The first thickness may be thicker than the second thickness. When the reinforcement beam 12 is implemented as a bumper reinforcement beam, it may be desirable for the first thickness to be thinner than the second thickness to provide easier deformation in side or corner impacts, as the second thickness being thicker provides greater resistance to deformation to straight-on collisions. Alternatively, the first thickness may be thicker than the second thickness when the reinforcement beam 12 is implemented as a side beam of a battery tray to provide strength reinforcement without additional weight increase. In one example, the sheet material first thickness of the outer beam profile 20 may be approximately 1 mm, and the sheet material second thickness of the inner beam profile 22 may be approximately 2 mm. In additional examples, the inner beam profile 22 may be greater than about 1.2 mm, greater than 1.5 mm, or greater than about 1.8 mm when the outer beam profile 20 is about 1 mm.

The inner beam profile 22, as shown in FIGS. 2-4, has an intermediate portion 46 that integrally interconnects between the upper wall 34 and the lower wall 36 of the inner beam profile 22 to together define a or C-shape as part of the inner beam profile 22. The intermediate portion 46 may have a groove, rib, or channel that is formed in the intermediate portion along a forward surface of the inner beam profile 22. The intermediate portion 46 of the inner beam profile 22 may be coupled to the front wall 30 of the outer beam profile 20, such as via adhesive, welding, or the like. If present, a groove, rib or channel may provide additional stiffness and support to the front portion of the reinforcement beam 12.

The upper and lower walls 34, 36 of the inner beam profile 22 may divide the hollow interior area of the hollow body formed by the outer beam profile 20 to form a plurality of elongated hollow areas 44′, 44″, 44″′ (FIG. 2). In doing so, the height of intermediate portion 46 of the inner beam profile 22 is configured such that ribs in the front wall portion 30 may be generally centered over the respective upper and lower hollow areas 44′, 44″′. The upper and lower walls 34, 36 of inner beam profile 22 may extend rearward at an angle α relative to the front wall 30. In some examples, the angle α is 90°, and the upper and lower walls 34, 36 are perpendicular to the front wall portion 26. In other examples, the upper and lower walls 34, 36 extend at an angle less than 90°, such as about 70° inclined away from each other. In other examples, the angle α for the upper wall 34 of inner beam profile extends rearward and upward at between 75° and 90° relative to the front wall 26. In some examples, the angle α for the lower wall of inner beam extends rearward and downward at an angle of between 75° and 90° relative to the front wall 26. It is also contemplated that the angle may be 78°, between 78° and 80°, between 78° and 82°, between 75° and 85°, between 75° and 90°, between 70° and 95°, or other suitable range.

Further, as shown in FIG. 2, the inner beam profile 22 and the outer beam profile may integrate at the edges or ends 56a, 56b of the roll-formed sheet material. The ends 56a, 56b may be formed to extend adjacent to and in parallel with the top and bottom walls 34, 36 of the inner beam profile. The ends 56a, 56b may be coupled to or joined with the adjacent top and bottom walls 34, 36, such as via welding, adhesive, or the like. In alternative examples, the ends 56a, 56b may be formed to extend adjacent to and in parallel with the rear wall portion 28. Similarly, the ends 56a, 56b may be coupled to or joined with the rear wall portion 28, such as via welding, adhesive, or the like. In additional alternatives, where the ends 56a, 56b extend along the rear wall portion 28, the rear wall portion 28 may include an offset portion to accommodate the ends 56a, 56b to yield a substantially planar rear aspect. For example, where the inner beam profile 22 extends a greater length of the reinforcement beam 12 proximate to a crush can 14, it may be desirable to provide a planar rear aspect to aid in securing the reinforcement beam 12 to the crush can 14. In the region of the lateral end sections 38a, 38b where the inner beam profile 22 is absent, the ends 56b, 56c may extend internal to the outer beam profile 20. In alternative examples, the ends 56b, 56c may be extended toward each other to create a closed cross-section. In such examples, the ends 56b, 56c may be coupled or joined together via welding, adhesive or the like.

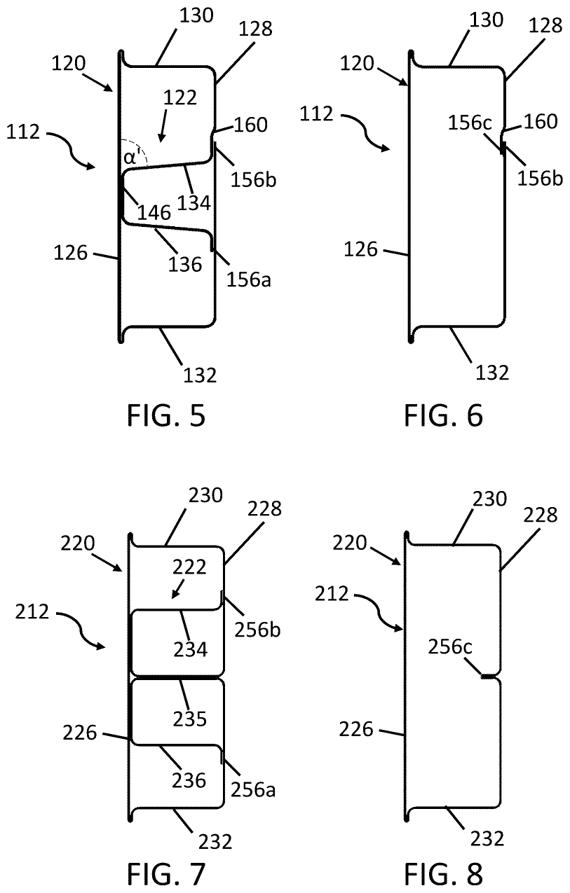

Additional examples of reinforcement beams having an inner beam profile and an outer beam profile are illustrated in FIGS. 5-20, showing various alternative features and variations from the reinforcement beam shown in FIGS. 2-4. Similar features may be indicated with similar reference numbers, incremented by 100, for example. The common aspects of the additional examples can be found in the integration of the inner beam profile and the outer beam profile such that it can be formed, for example, from a single sheet material in a roll-forming process. Similarly, the inner beam profile may extend only a portion of the total length of the reinforcement beam. The remainder of the length may extend the outer beam profile absent the inner beam profile. Upper and lower flanges may be provided on the front wall portion to aid in intercepting and concentrating impact load forces that may be experienced, for example, in a vehicle collision. While certain features and differences of the additional examples, may be discussed in detail below, common features and aspects should be further understood from the discussion above to apply similarly to the examples below.

As shown in FIGS. 5 and 6, a reinforcement beam 112, includes an outer beam profile 120 and an inner beam profile 122. The inner beam profile 122 includes an upper wall 134 and a lower wall 136 that extend at an angle α′ from the front wall 126 of 5° away from perpendicular, where the upper wall 134 is angled upwards and the lower wall 136 is angled downwards. The first edge or end 156a of the sheet material forming the reinforcement beam 112 lies internal to the outer beam profile 120. The rear wall portion 128 include an offset portion 160 to accommodate the second edge or end 156b and provide a substantially planar rear aspect. FIG. 6 illustrates the reinforcement beam 112 absent the inner beam profile 122, such as in lateral end sections, when the inner beam profile 122 is present only in a center section. The sheet material has been cut or trimmed at the edge or end 156c, which overlaps the second end 156b to form a closed cross section in the lateral end sections.

As shown in FIGS. 7 and 8, a reinforcement beam 212 includes an outer beam profile 220 and an inner beam profile 222. The inner bream profile 222 includes an upper wall 234, a middle wall 235 and a lower wall 236. The edges or ends 256a, b may be joined to the rear wall portion 228 via welding, adhesive, or the like. FIG. 8 illustrates the reinforcement beam 212 absent the inner beam profile 222. The middle wall 235 may extend only partially through the outer beam profile 120 and may be joined into a single common end 256c via welding, adhesive or the like, to provide a closed cross section of the outer beam profile 220 with a planar rear aspect along the rear wall portion 228.

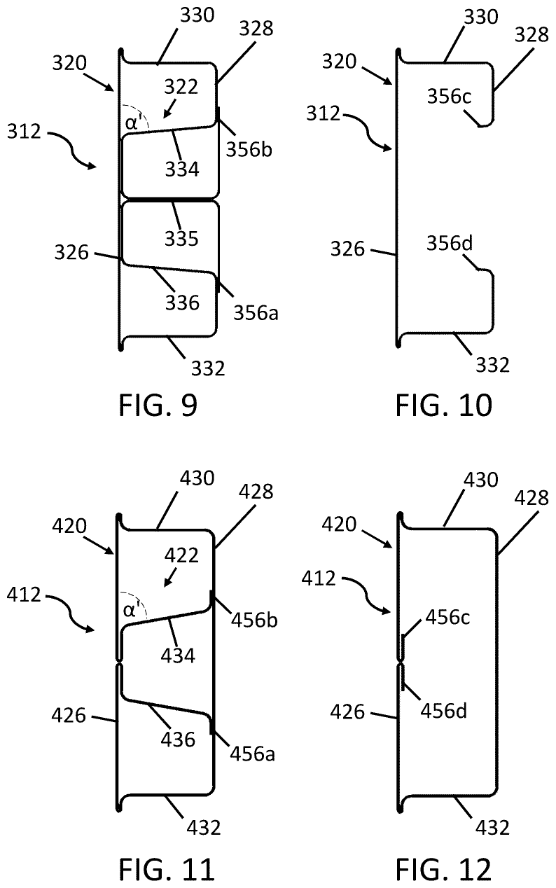

As shown in FIGS. 9 and 10, a reinforcement beam 312 includes an outer beam profile 320 and an inner beam profile 322. The inner beam profile 322 includes an upper wall 334, middle call 335, and a lower wall 336. The edges or ends 356a, b may be disposed outside the outer beam profile 320 adjacent the rear wall portion 328. The ends 356a, b may be joined to the rear wall portion 328 via welding, adhesive, or the like. FIG. 10 illustrates the reinforcement beam 312 absent the inner beam profile 322. The sheet material forming the reinforcement beam 312 may be trimmed so that the upper wall 334 and the lower wall 336 extend partially across the outer beam profile 320 to ends 356c, d.

As shown in FIGS. 11 and 12, a reinforcement beam 412 includes an outer beam profile 420 and an inner beam profile 422. The inner beam profile 422 includes an upper wall 434, and a lower wall 436 that extend at an angle α′ from the front wall 426 of 10° away from perpendicular, where the upper wall 434 is angled upwards and the lower wall 436 is angled downwards. The edges or ends 456a, b may be disposed inside the outer beam profile 420 adjacent the rear wall portion 428. The ends 456a, b may be joined to the rear wall portion 428 via welding, adhesive, or the like. FIG. 12 illustrates the reinforcement beam 412 absent the inner beam profile 422. The sheet material forming the reinforcement beam 412 may be trimmed so that the upper wall 434 and the lower wall 436 extend adjacent the front wall portion 426 to ends 456c, d.

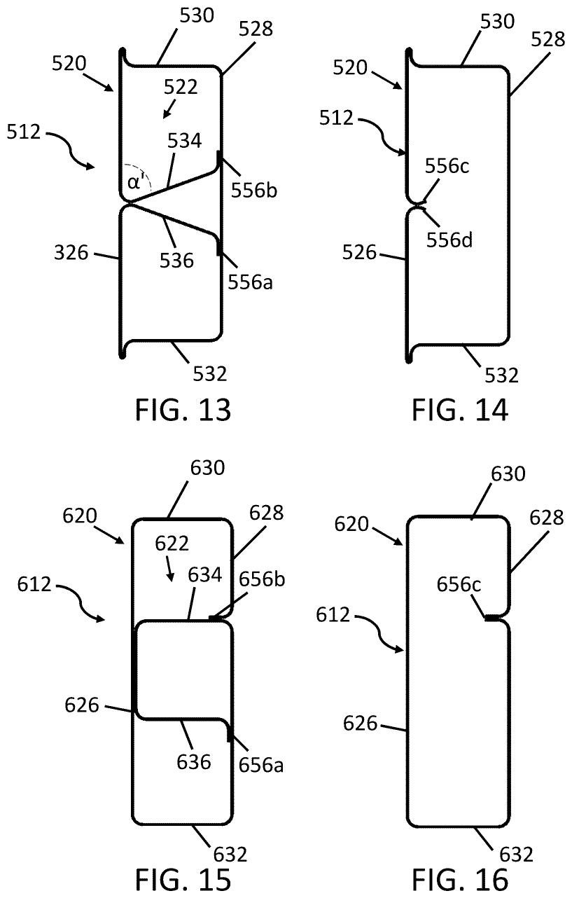

As shown in FIGS. 13 and 14, a reinforcement beam 512 includes an outer beam profile 520 and an inner beam profile 522. The inner beam profile 522 includes an upper wall 534, and a lower wall 536 that extend at an angle α′ from the front wall 526 of 20° away from perpendicular, where the upper wall 534 is angled upwards and the lower wall 536 is angled downwards. The edges or ends 556a, b may be disposed inside the outer beam profile 520 adjacent the rear wall portion 528. The ends 556a, b may be joined to the rear wall portion 528 via welding, adhesive, or the like. FIG. 14 illustrates the reinforcement beam 512 absent the inner beam profile 522. The sheet material forming the reinforcement beam 512 may be trimmed so that the upper wall 534 and the lower wall 536 extend inwardly of the outer beam profile 520 adjacent to ends 556c, d.

As shown in FIGS. 15 and 16, a reinforcement beam 612 includes an outer beam profile 620 and an inner beam profile 622. The inner bream profile 622 includes an upper wall 634 and a lower wall 636. The edges or ends 656a, b may be joined to the rear wall portion 628 via welding, adhesive, or the like. FIG. 16 illustrates the reinforcement beam 612 absent the inner beam profile 622. The top wall 634 may extend only partially through the outer beam profile 620 and may be joined into a single common end 656c via welding, adhesive or the like, to provide a closed cross section of the outer beam profile 620 with a planar rear aspect along the rear wall portion 628. The common end 656c may be disposed closer to the top wall portion 630 than the bottom wall portion 632.

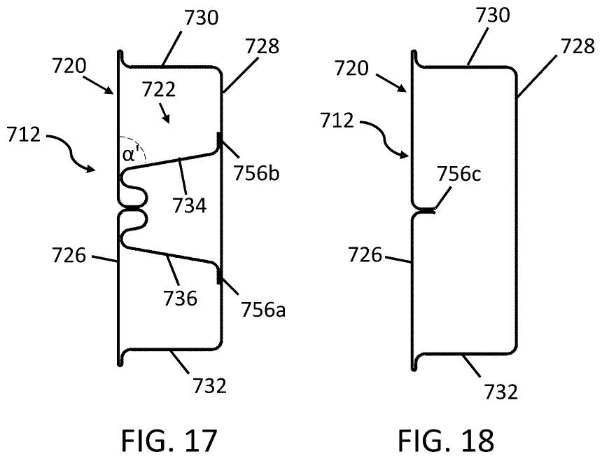

As shown in FIGS. 17 and 18, a reinforcement beam 712 includes an outer beam profile 720 and an inner beam profile 722. The inner beam profile 722 includes an upper wall 734, and a lower wall 736 that circle back toward the front wall portion 720 before extending at an angle α′ from the front wall 726 of 10° away from perpendicular, where the upper wall 734 is angled upwards and the lower wall 736 is angled downwards. The edges or ends 756a, b may be disposed inside the outer beam profile 720 adjacent the rear wall portion 728. The ends 756a, b may be joined to the rear wall portion 528 via welding, adhesive, or the like. FIG. 18 illustrates the reinforcement beam 712 absent the inner beam profile 722. The sheet material forming the reinforcement beam 712 may be trimmed so that the upper wall 734 and the lower wall 736 extend inwardly of the outer beam profile 720 adjacent to a common end 556c joined together to provide a closed cross section of the outer beam profile 720.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A bumper reinforcement beam configured to be supported by crush cans at a vehicle frame, the bumper reinforcement beam comprising:
an outer beam profile having an elongated hollow body formed from a metal sheet material and configured to span laterally between the crush cans, the hollow body having a front wall portion and a rear wall portion extending along a length defined between a first end and a second end of the hollow body; and
an inner beam profile formed integrally with the outer beam profile disposed along a central section of the reinforcement beam between first and second lateral end sections, the inner beam profile having an upper wall and a lower wall that each extend between the front wall portion and the rear wall portion of the outer beam.

2. The bumper reinforcement beam of claim 1, wherein the inner beam profile further comprises a middle wall disposed between the upper wall and the lower wall and extending between the front wall portion and the rear wall portion.

3. The bumper reinforcement beam of claim 1, wherein the central section has a first length, the first and second lateral end sections having respective second and third lengths, and wherein the first length is less than the sum of the second and third lengths.

4. The bumper reinforcement beam of claim 1, wherein the inner beam profile comprises an intermediate portion that interconnects between the upper wall and the lower wall to together define a channel disposed within the outer beam profile.

5. The bumper reinforcement beam of claim 4, wherein the intermediate portion is adjacent the front wall portion of the outer beam profile.

6. The bumper reinforcement beam of claim 1, comprising a single sheet material forming the outer beam profile and the inner beam profile, the single sheet material comprising a first edge and a second edge, the first and second edges disposed adjacent to and coupled with the rear wall portion of the outer beam profile.

7. The bumper reinforcement beam of claim 1, comprising a single sheet material forming the outer beam profile and the inner beam profile, the single sheet material comprising a first edge and a second edge, the first and second edges disposed internal to the outer beam profile.

8. The bumper reinforcement beam of claim 1, a single sheet material forming the outer beam profile and the inner beam profile, the single sheet material comprising a first edge and a second edge in the central section, the single sheet material comprising a third edge and a fourth edge in the first and second lateral end sections.

9. The bumper reinforcement beam of claim 8, wherein the first and second edges are different from the third and fourth edges.

10. The bumper reinforcement beam of claim 8, wherein the third and fourth edges are spaced apart.

11. The bumper reinforcement beam of claim 8, wherein the third and fourth edges are joined together to form a closed cross section of the outer beam profile in the first and second lateral end sections.

12. The bumper reinforcement beam of claim 1, wherein the upper wall of the inner beam profile extends rearward and upward at an angle of greater than 70° relative to the front wall portion.

13. The bumper reinforcement beam of claim 1, wherein the upper and lower walls of the inner beam profile divide an interior volume of the hollow body to form a plurality of elongated hollow areas.

14. A bumper reinforcement beam configured to be supported by crush cans at a vehicle frame, the bumper reinforcement beam comprising:
a beam comprising a front wall portion, a rear wall portion and upper and lower wall portions, to define an outer beam profile having a length configured to span between the crush cans; and
an inner beam profile integrally formed with the outer beam profile and comprising a shear wall that extends between the front wall portion and the rear wall portion,
wherein the inner beam profile has a length that is less than the length of the outer beam profile.

15. The bumper reinforcement beam of claim 14, wherein the inner beam profile is disposed along a central section of the beam between first and second lateral end sections thereof.

16. The bumper reinforcement beam of claim 15, wherein the inner beam profile further comprises a second shear wall disposed between the upper wall and the lower wall portions and extending between the front wall portion and the rear wall portion, and wherein the shear walls of the inner beam profile divide an interior volume of the beam to form a plurality of elongated hollow areas along the central section.

17. The bumper reinforcement beam of claim 16, wherein the central section has a first length, the first and second lateral end sections having respective second and third lengths, and wherein the first length is less than the sum of the second and third lengths.

18. The bumper reinforcement beam of claim 16, wherein the inner beam profile comprises an intermediate portion that interconnects between the shear walls to together define a channel disposed within the outer beam profile, and wherein the intermediate portion is adjacent the front wall portion of the outer beam profile.

19. The bumper reinforcement beam of claim 14, comprising a single sheet material forming the outer beam profile and the inner beam profile.

20. A reinforcement beam for a vehicle, the reinforcement beam comprising:
an outer beam profile having a front wall portion, a rear wall portion, and upper and lower flanges that extend from the outer beam profile along respective upper and lower edges of the outer beam profile to define an elongated hollow body with a length defined between opposing ends of the outer beam profile; and
an inner beam profile comprising a C-shape having an upper shear wall and a lower shear wall that each extend between the front wall portion and the rear wall portion,
wherein the inner beam profile has a length that is less than half the length of the elongated hollow body.
